(19) United States
(12) Patent Application Publication
(10) Pub. No.: US 2012/0298727 A1
(43) Pub. Date: Nov. 29, 2012

(54) SELF-GUIDING FRICTION STIR WELDING APPARATUS AND METHOD

(75) Inventors: Israel Stol, Pittsburgh, PA (US); James T. Burg, Verona, PA (US)

(73) Assignee: ALCOA INC., Pittsburgh, PA (US)

(21) Appl. No.: 13/480,065

(22) Filed: May 24, 2012

Related U.S. Application Data
(60) Provisional application No. 61/490,270, filed on May 26, 2011.

(51) Int. Cl. B23K 20/12

(52) U.S. Cl. 228/112.1; 228/2.1

(57) ABSTRACT

One embodiment of a friction stir welding apparatus comprises two friction stir welding tools on a carriage. The first friction stir welding tool is capable of rotating in a first direction. The second friction stir welding tool is capable of rotating in a second direction, counter to the first direction. The first friction stir welding tool and the second friction stir welding tool are operable to weld simultaneously and in tandem along an intersection of at least two work pieces.

### CROSS-REFERENCE TO RELATED APPLICATIONS

This patent application claims priority to U.S. Provisional Patent Application No. 61/490,270, filed May 26, 2011, which is incorporated herein by reference in its entirety.

### BACKGROUND

Most friction stir welding machines currently used are designed for stationary installation and the welding heads and parts are laterally constrained. Current portable fiction stir welding system also contain added parts that physically constrain lateral movement of the machines during welding.

### SUMMARY

In one embodiment of a friction stir welding apparatus, a carriage supports two friction stir welding tools. A carriage is any apparatus capable of supporting friction stir welding tools in operation. The first friction stir welding tool is capable of rotating in a first direction. The second friction stir welding tool is capable of rotating in a second direction, counter to the first direction. The first friction stir welding tool and the second friction stir welding tool are operable to weld simultaneously and in tandem, one behind the other relative to the welding direction, along an intersection of at least two work pieces. “At least two work pieces” means any object or objects that have or form an intersection capable of being friction stir welded. In some embodiments, the first friction stir welding tool and the second friction stir welding tool are operable to weld simultaneously and in tandem along a seam formed by the abutment of at least two work pieces. In some embodiments, when welding, the first friction stir welding tool is capable of exerting a greater force on a first work piece than on a second work piece and the second friction stir welding tool is capable of exerting a greater force on the second work piece than on the first work piece so that a sum of the forces of the first and second stir welding tools on the work pieces urges the carriage and the friction stir welding tools along the seam or intersection in a substantially linear path.

In some embodiments, the second friction stir welding tool is separated from the first friction stir welding tool by a length L along the carriage. In some embodiments, the first and second friction stir welding tools are capable of traveling along substantially the same linear path. In some embodiments, the second friction stir welding tool is separated from the first friction stir welding tool by a width, W along the carriage. In some embodiments, the first and second friction stir welding tools are capable of traveling along distinct, parallel linear paths.

In some embodiments, the first friction stir welding tool is the same size and has the same design as the second friction stir welding tool. The size refers to the diameters of the pin and shoulder of the friction stir welding tool. Design of the friction stir welding tool refers to shapes, pitch and slope angle of the threads on the pin and shoulder of the friction stir welding tool. Examples of design features include, a flat on a pin or a single or multiple parallel thread on a shoulder of a friction stir welding tool. In some embodiments, the first friction stir welding tool and the second friction stir welding tool each have a pin and the pin of the first friction stir welding tool is a different size than the pin of the second friction stir welding tool. A pin is the part of the friction stir welding tool that is inserted into the intersection of the work pieces and rotates during welding.

Some embodiments include a mechanism capable of adjusting a turning speed of the first friction stir welding tool or the second friction stir welding tool when welding so that the sum of the forces of the first and second stir welding tools on the work pieces continue to urge the carriage and the friction stir welding tools along the seam or intersection in a substantially linear path as temperature of metal along the seam or intersection varies. In some embodiments, the friction stir welding tools are preprogrammed to vary their speeds based on the predicted temperature variations that will occur during welding. In some embodiments, an algorithm will be used to adjust the speed of the friction stir welding tools based on real time changes in temperature in the weld zone of the work pieces during welding.

In some embodiments, a third friction stir welding tool is held by the carriage. The first friction stir welding tool, the second friction stir welding tool and the third friction stir welding tool are operable to weld simultaneously and in tandem along the intersection of at least two work pieces. When welding, a sum of the forces of the stir welding tools on the work pieces urges the carriage and the friction stir welding tools along the seam or intersection in a substantially linear path. In some embodiments, multiple friction stir welding tools are held by the carriage. When welding, a sum of the forces of the stir welding tools on the work pieces urges the carriage and the friction stir welding tools along the seam or intersection in a substantially linear path.

A method of friction stir welding comprises: positioning a carriage having at least a first friction stir welding tool and a second friction stir welding tool so that a pin of the first friction stir welding tool and a pin of the second friction stir welding tool are in operable communication with an intersection of at least two work pieces; rotating in a first direction the pin of the first friction stir welding tool; and rotating the pin of the second friction stir welding tool in a second direction, counter to the first direction, simultaneously and in tandem with the rotation of the pin of the first friction stir welding tool; wherein the first friction stir welding tool exerts a greater force on a first work piece than on a second work piece and the second friction stir welding tool exerts a greater force on the second work piece than on the first work piece so that a sum of the forces of the first and second stir welding tools on the first and second work pieces urges the carriage and the friction stir welding tools along the intersection of the at least two work pieces in a substantially linear path.

In some embodiments, the second friction stir welding tool is separated from the first friction stir welding tool by a length L along the carriage. In some embodiments, the first and second friction stir welding tools travel along substantially the same linear path. In some embodiments, the second friction stir welding tool is separated from the first friction stir welding tool by a width W along the carriage. In some embodiments, the first and second friction stir welding tools travel along distinct, parallel linear paths.

In some embodiments, the first friction stir welding tool is the same size and has a same design as the second friction stir welding tool. In some embodiments, the first friction stir welding tool and the second friction stir welding tool each have a pin and the pin of the first friction stir welding tool is a different size than the pin of the second friction stir welding tool.

In some embodiments the method further comprises adjusting a turning speed of the first friction stir welding tool or the second friction stir welding tool when welding so that the sum of the forces of the first and second stir welding tools on the work pieces continue to urge the carriage and the friction stir welding tools along the intersection in a substantially linear path as temperature of metal along the seam varies.

Another embodiment of a friction stir welding apparatus comprises: a carriage capable of being pulled by a cable; a first friction stir welding tool held by the carriage; and a torque-compensation arm held by the carriage and capable of being pulled by a cable.

### BRIEF DESCRIPTION OF THE DRAWINGS

FIG. 1 shows a side view of a friction stir welding apparatus according to one embodiment of the invention.

FIG. 2 shows a partial cross-section view of the embodiment of FIG. 1 taken from Section A.

FIG. 3 shows the underside of an abutment of a first work piece and a second work piece forming a square-butt joint while being welded with the friction stir welding apparatus shown in FIGS. 1 and 2.

FIG. 4 shows a top-down view of the force vectors and plasticized regions created by operation of the embodiment of the friction stir welding apparatus shown in FIGS. 1 and 2.

FIG. 5 shows the underside of an abutment of a first work piece and a second work piece forming a square-butt joint while being welded with a friction stir welding apparatus according to another embodiment.

FIG. 6 shows the underside of an abutment of a first work piece and a second work piece forming a square-butt joint while being welding with a friction stir welding apparatus according to yet another embodiment.

FIG. 7 shows a partial cross-section side view of a friction stir welding apparatus according to yet another embodiment of the invention.

FIG. 8 shows a partial cross-section side view of a friction stir welding apparatus according to yet another embodiment of the invention.

FIG. 9 shows a side view of a friction stir welding apparatus according to yet another embodiment of the invention.

FIG. 10 shows a side perspective view of an embodiment of a friction stir welding apparatus having a carriage and a torque compensation arm.

FIG. 11 shows the opposite side perspective view of the embodiment shown in FIG. 10.

FIG. 12 shows the tope view of the embodiment shown in FIGS. 10 and 11.

### DESCRIPTION

Reference will now be made in detail to the accompanying drawings, which at least assist in illustrating various pertinent embodiments of the present disclosure.

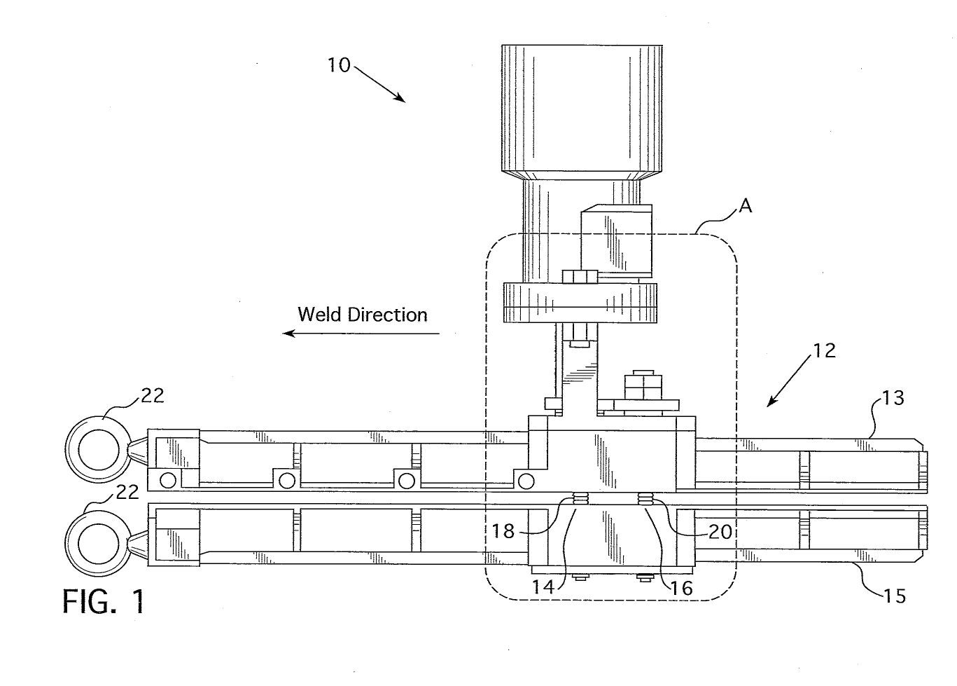

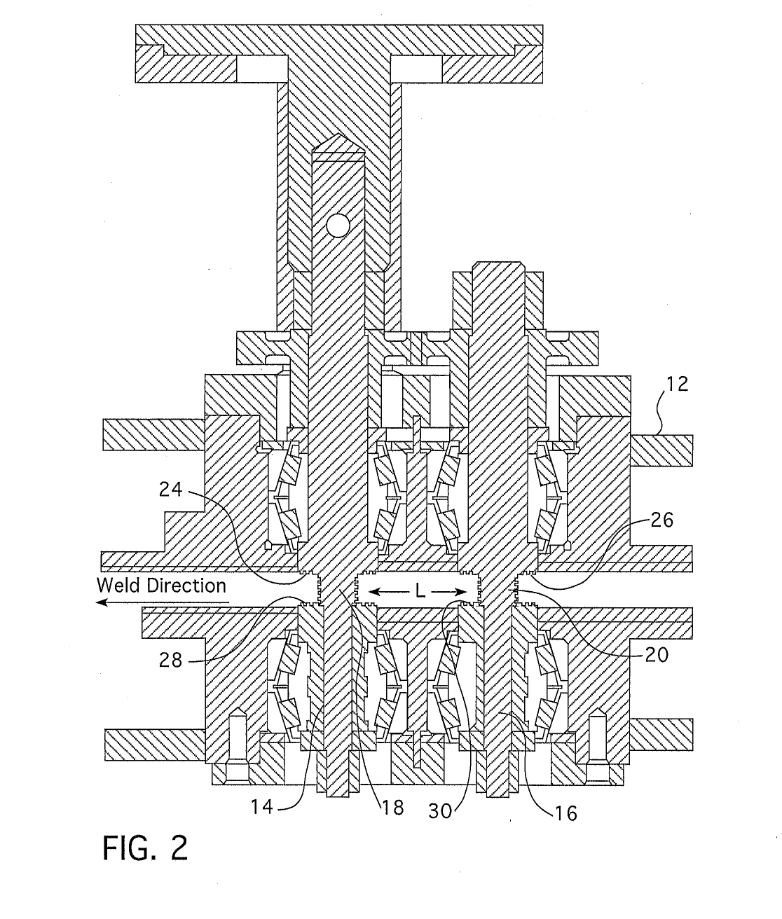

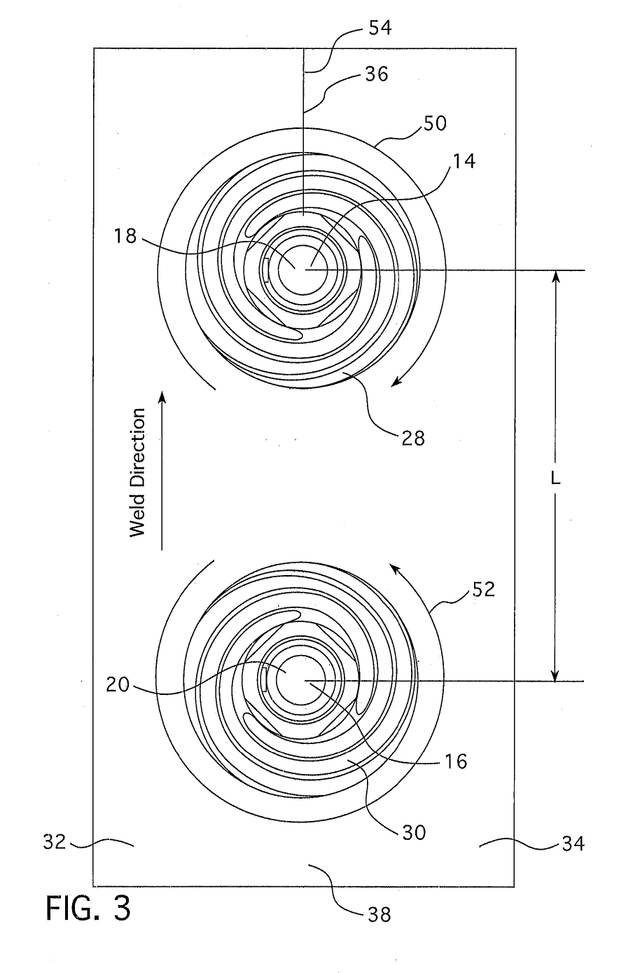

One embodiment of the invention is illustrated in FIG. 1. FIG. 2 shows a partial cross-section view of the embodiment of FIG. 1 taken from Section A. The friction stir welding apparatus 10 in FIG. 1 comprises a carriage 12 for carrying a first friction stir welding tool 14, having a pin 18 a top shoulder 24 and a bottom shoulder 28, and a second friction stir welding tool 16, having a pin 20, a top shoulder 26 and a bottom shoulder 30. The carriage 12 has a top portion 13 and a bottom portion 15. The carriage 12 also has rings 22 so that a cable may be attached to and pull the carriage. The friction stir welding tools 14 and 16 are operable to weld in the direction of rings 22. Work pieces 32 and 34, shown in FIGS. 3-6, to be welded together are sandwiched between the top portion 13 and the bottom portion 15 of the carriage 12 during welding.

FIG. 3 shows the underside of an abutment of a first work piece 32 and a second work piece 34 to form a square-butt joint 36. The square butt joint 36 forms a seam 54. The square-butt joint 36 can be observed ahead of the first friction stir welding tool 14 with respect to the weld direction. A completed friction stir weld 38 can be seen following the second friction stir welding tool 16.

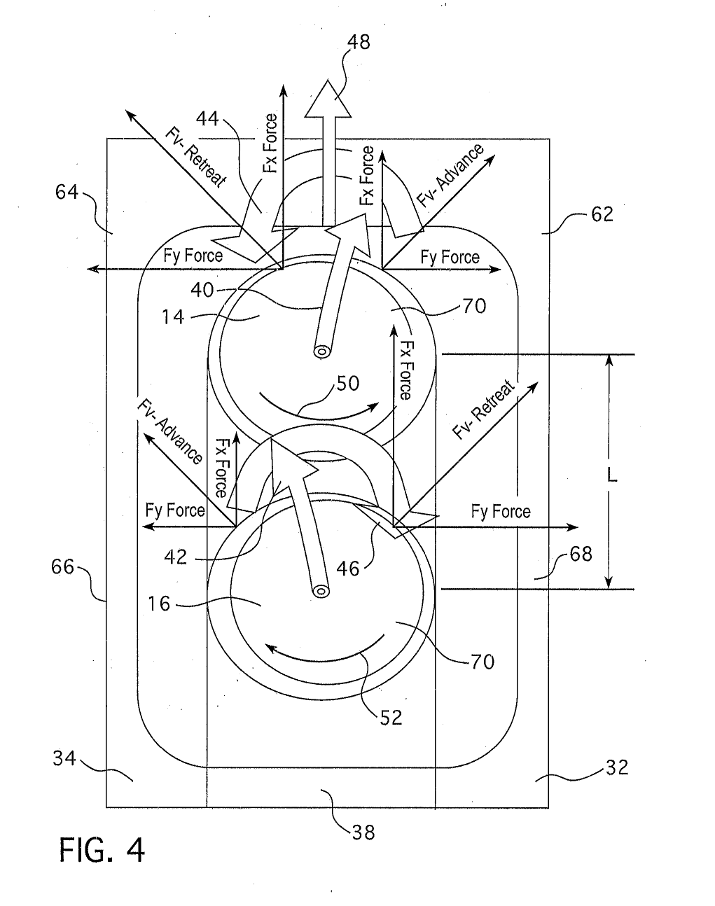

FIG. 4 shows a top-down view of the force vectors and plasticized regions associated with operation of the embodiment of the friction stir welding apparatus 10 shown in FIGS. 1-3. In the embodiments shown in FIGS. 1-4, the second friction stir welding tool is separated from the first friction stir welding tool by a length L along the carriage. As shown in FIGS. 3 and 4, In some embodiments, the first and second friction stir welding tools travel along substantially the same linear path.

As illustrated in FIGS. 3 and 4, the first friction stir welding tool 14 is operable to rotate in a first direction 50. The second friction stir welding tool 16 is operable to rotate in a second direction 52, counter to the first direction 50. In the embodiment shown in FIGS. 1-4, the first friction stir welding tool 14 and the second friction stir welding tool 16 are operable to weld simultaneously and in tandem along the intersection of the first work piece 32 and the second work piece 34.

In the embodiment of the friction stir welding apparatus 10 shown in FIGS. 1-4, the first friction stir welding tool 14 is operable to exert a greater force on a first work piece 32 than on a second work piece 34 and the second friction stir welding tool 16 is operable to exert a greater force on the second work piece than on the first work piece so that a sum of the forces of the first and second stir welding tools on the work pieces urges the carriage 12 and the friction stir welding tools along the seam 54 or intersection in a substantially linear path without the need for mechanized tracks, thickened lands or railings to keep the friction stir welding tools at the seam as they are being pulled by a cable attached to one or more rings 22. The carriage 12 may be pulled by the ring 22 attached to the top portion 13 of the carriage, the bottom portion 15 of the carriage or both.

When friction stir welding work pieces 32 and 34 together, there are primary net reacting forces, Fx and Fy and Fz illustrated in FIG. 4, exerted by the friction stir welding tools 14 and 16 onto the work pieces as the friction stir welding tools move through the work pieces. These forces are equal and opposed to the resistances by the work pieces 32 and 34 to the advancement of the tools 14 and 16 through them. With respect to the first friction stir welding tool 14, since the temperature distribution about the welding region during friction stir welding is skewed, so the first work piece 32 on the advancing side 62 of the first friction stir welding tool is always hotter than the second work piece 34 on the retracting side 64 of the first friction stir welding tool around the welding region, and, therefore, the plasticized region 70 is thicker at the advancing side of the first friction stir welding tool than at its retracting side. As a result, the force vectors Fv-Retreat, on the retracting side 64 of the first friction stir welding tool 14, are higher than the force vectors Fv-Advance, on the advancing side 62 of the first friction stir welding tool. These differences (i.e. in the force vectors and thickness of the plasticized region) tend to push and veer the first friction stir welding tool 14 and plasticized region about it towards the advancing side 62 of the first friction stir welding tool 14, where they encounter the path of least resistance. In addition to the tendency of the weld region to be pushed and veered towards the advancing side 62 of the first friction stir welding tool 14, there is also torque, imparted by the rotating friction stir welding tool, acting on the work pieces 32 and 34 that tends to turn them in the direction opposite to this veering. Likewise, the force vectors of the second friction stir welding tool 16 push and veer the second friction stir welding tool and plasticized region created by the second friction stir welding tool toward the advancing side 66 of the friction stir welding tool and away from the retracting side 68 of the friction stir welding tool.

The force vector at the joint, Fx, which is the force applied by the friction stir welding tool to the edges of the work pieces 32 and 34 at the seam 54 is smaller than the Fv-Advance and Fv-Retreat vectors. The reason that Fx is smaller, stems from the least resistance to the advancement of the friction stir welding tool and is caused by the two-dimensional heat flow condition at the edges of the work pieces 32 and 34, which localized the welding heat at these edges for a longer time than the other areas of the parts that are in contact with the advancing friction stir welding tool before conducting this heat away. This heat localization makes the edges of the work pieces 32 and 34 softer, less resistant to the advancement of the tool and more “plasticizable”. Therefore, the least resistance to the advancement of the friction stir welding tool is at the seam 54. Therefore, by providing a first friction stir welding tool 14, configured to rotate in a first direction 50, and a second friction stir welding tool 16, configured to rotate in a second direction 52, each friction stir welding tool being attached to the carriage 12, the forces urging the first friction stir welding tool toward the advancing side 62 of the first friction stir welding tool can be balanced with the forces urging the second friction stir welding tool toward the advancing side 66 of the second friction stir welding tool, and the carriage along with the first and second friction stir welding tools will be urged along seam 54, which is the path of least resistance.

In some embodiments, the portable friction stir welding system 10 will automatically track the weld seam 54 so the first friction stir welding tool 14 and the second friction stir welding tool 16 are always nearly-centered on the seam. In some embodiments, the two counter-rotating friction stir welding tools 14 and 16 mutually cancel the tendency of each tool and its surrounding plasticized region to be pushed and veered toward the advancing side and the tendency to be spun by the friction stir welding tool's torque absence a restraint. Some embodiments of the invention do not include the use of mechanized tracks, thickened lands or railings to guide and keep the friction stir welding tools 14 and 16 at the correct lateral position relative to the joint or to resist the torque imparted into the parts being welded by the rotating friction stir welding tool.

In order to compensate for different heat distributions encountered by the first and second, or leading and trailing, friction stir welding tools and the depth of the top shoulder indentation or “dip” into the work pieces, in some embodiments of the invention, prior to welding, the torque and heat input of each of the friction stir welding tools in the system may be balanced by one or a combination of the following: a) offsetting the trailing friction stir welding tool from the leading friction stir welding tool by a width along the carriage; b) using a trailing tool having a design and geometry (e.g. smaller diameter) resulting in a lower welding heat input than the one generated by a leading tool; c) an independent speed (RPM) adjustable mechanism (e.g. electric, electromechanical, pneumatic, hydraulic or mechanical, such as a tapered gear) for turning a trailing friction stir welding tool.

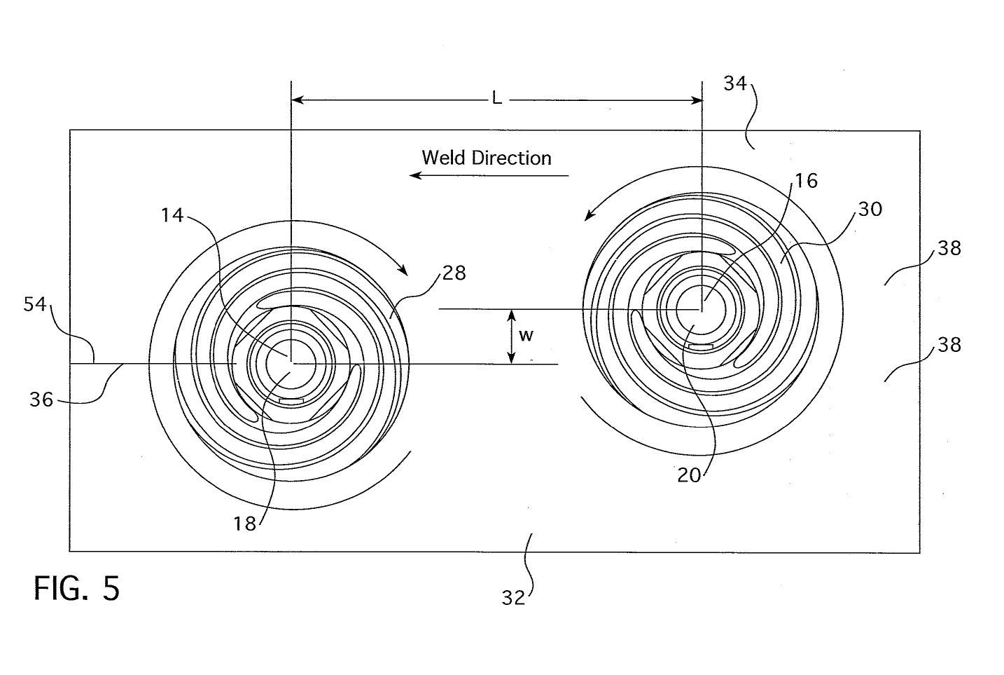

In the embodiment shown in FIG. 5, the second friction stir welding tool 16 is separated from the first friction stir welding tool 14 by a width W and a length L along the carriage. In this embodiment, the first and second friction stir welding tools 14 and 16, respectively, travel along distinct, parallel linear paths. The tool offset in this embodiment may be used to balance the torques of the two friction stir welding tools 14 and 16. This embodiment may also allow for larger variations in the gap at the seam 54 between the first work piece 32 and the second work piece 34 and straightness of the seam than in previous embodiments.

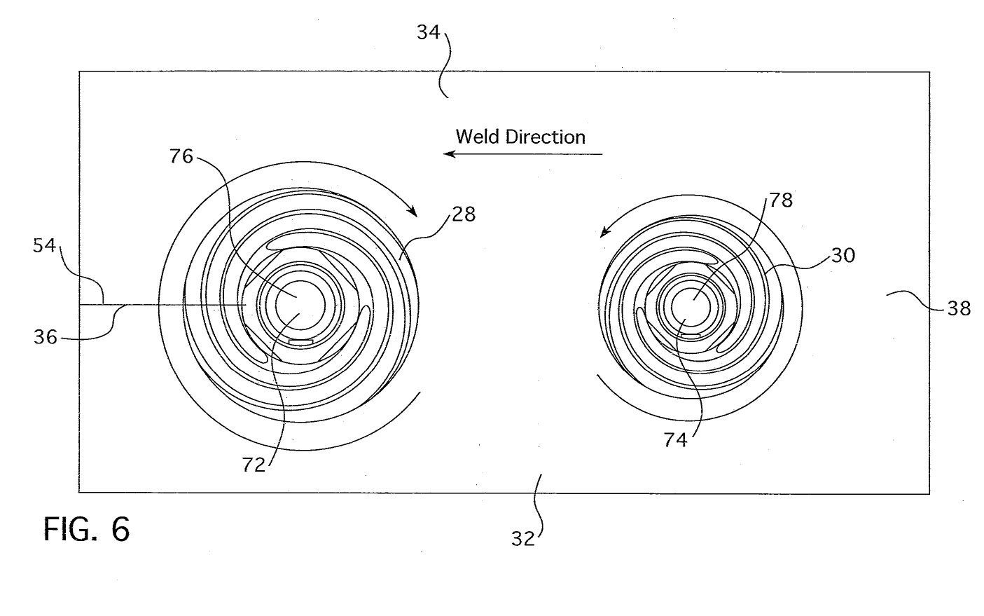

In the embodiments shown in FIGS. 1-5, the first friction stir welding tool 14 is the same size and has the same design as the second friction stir welding tool 16. In the embodiment shown in FIG. 6, the pin 72 of the first friction stir welding tool 76 is larger than the pin 74 of the second friction stir welding tool 78. Since the pin 72 of the first friction stir welding tool 76 is larger, it can run at a slower speed than the pin 74 of the second friction stir welding tool 78 while the first friction stir welding tool exerts a greater force on a first work piece than on a second work piece and the second friction stir welding tool exerts a greater force on the second work piece than on the first work piece so that a sum of the forces of the first and second stir welding tools on the work pieces urges the carriage and the friction stir welding tools along the seam or intersection in a substantially linear path. Also, as shown, shoulder 28 is larger than shoulder 30. Using tools of different size is one way to balance the torque of the first friction stir welding tool 76 and the second friction stir welding tool 78.

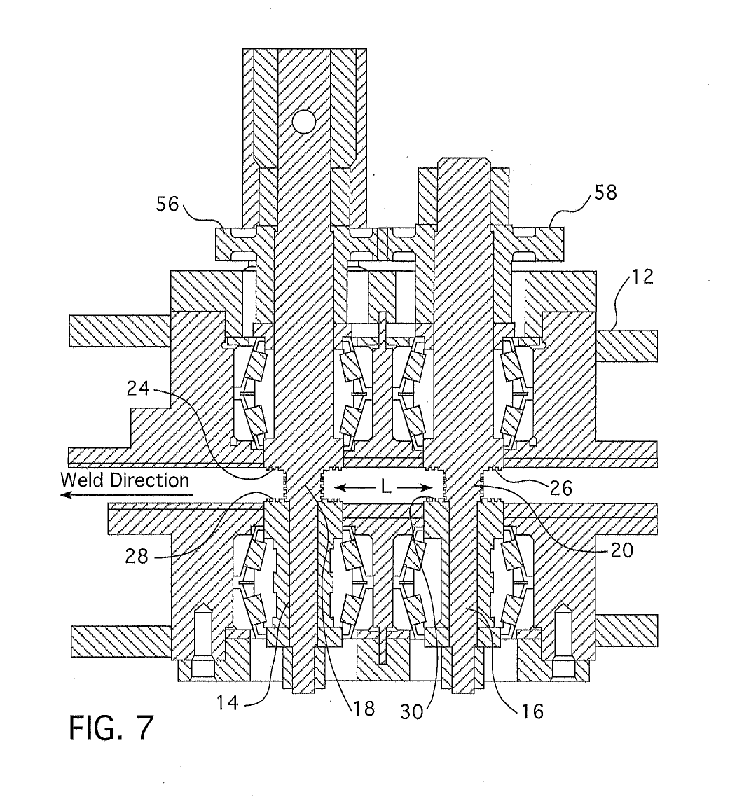

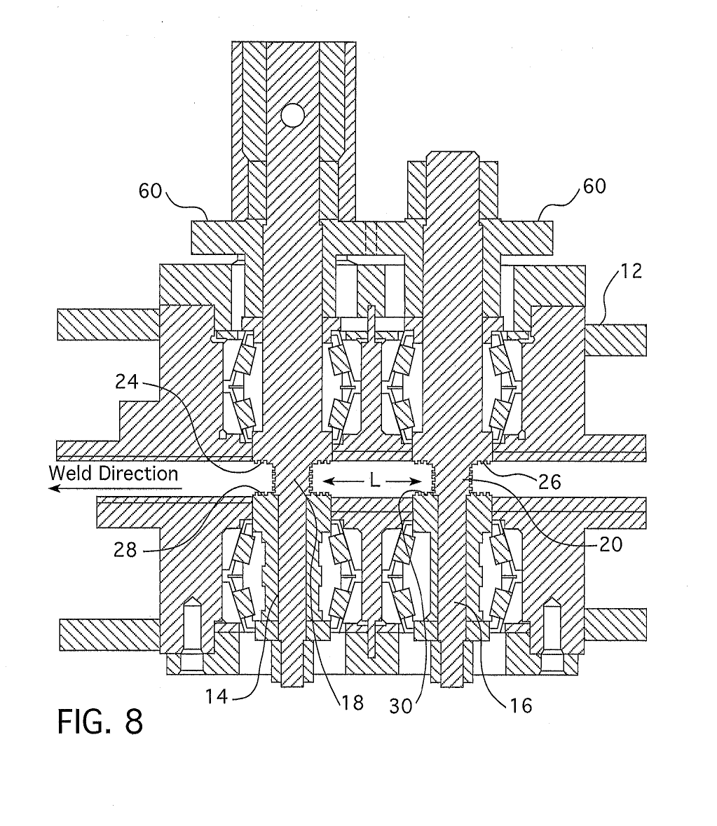

The embodiments shown in FIGS. 7 and 8 include a mechanism for adjusting a turning speed of the second friction stir welding tool 16 when welding so that the sum of the forces of the first and second stir welding tools 14 and 16, respectively, on the work pieces 32 and 34 continue to urge the carriage 12 and the friction stir welding tools along the seam 54 or intersection in a substantially linear path as temperature of metal along the seam or intersection varies.

In the embodiment shown in FIG. 7, the diameter of the gear 56 of the first friction stir welding tool 14 is smaller than the diameter the gear 58 of the second friction stir welding tool 16. By varying the diameters of the spur gear the second friction stir welding tool will rotate at a different speed than the first friction stir welding.

In the embodiment shown in FIG. 8, either both the friction stir welding tools 14 and 16 each have a transmission 60 that is adjustable or only the second friction stir welding tool 16 has a transmission that is adjustable to allow for a variable speed ratio between the first friction stir welding tool and the second friction stir welding tool. This difference in speed is one way to balance the torques of the friction stir welding tools 14 and 16 during welding and to reduce the driving force Fx on the friction stir welding apparatus 10 required relative to a conventional friction stir welding apparatus having one friction stir welding tool. This way, the turning speed of a trailing tool could be adjusted to a lower RPM than that of the leading tool while welding until the side veering of the welding head is nearly eliminated. Lowering the RPM of a trailing tool lowers the weld heat input from the tool, thus making up for the preheat generation by a leading tool. In some embodiments, the transmission 60 of friction stir welding tools are preprogrammed to vary speed based on the predicted temperature variations that will occur during welding. In some embodiments, an algorithm will be used to adjust the speed of the friction stir welding tools based on real time changes in temperature in the weld zone of the work pieces during welding.

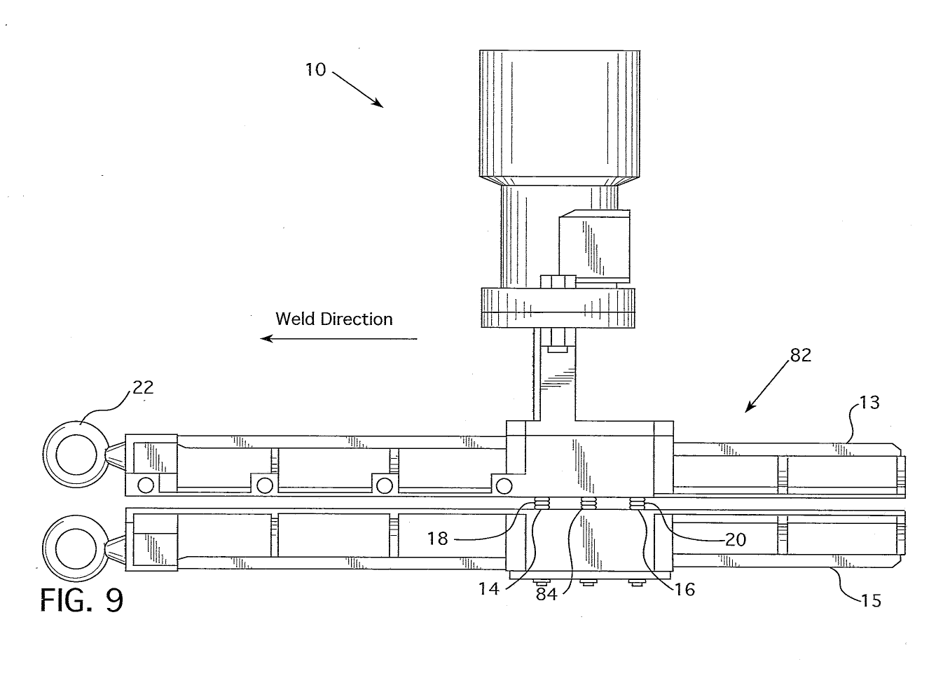

In the embodiment shown in FIG. 9, a third friction stir welding tool 84 is held by the carriage 82. When welding, a sum of the forces of the stir welding tools 14, 16 and 84 on the work pieces 32 and 34 urges the carriage 82 and the friction stir welding tools along the seam 54 or intersection in a substantially linear path. In some embodiments, multiple friction stir welding tools are held by the carriage. When welding, a sum of the forces of the stir welding tools on the work pieces urges the carriage and the friction stir welding tools along the seam or intersection in a substantially linear path.

In some embodiments of the invention, any gaps between the work pieces at the joint are kept to a minimum during welding by forcing the edges of the parts together with the aid of welding fixtures (not shown), e.g. side clamps, and/or tack welds. In some embodiments, the work pieces are constrained from moving up and down (z-direction) during welding using clamps, tack welds and/or the tool itself. Some embodiments of the invention include a bobbin type friction stir welding tool designed to weld multiple parallel joints.

The friction stir welding system may be portable or stationary. Some embodiments of the invention include multi-shouldered bobbin type friction stir welding tools. Some embodiments of the invention include convention anvil-backed friction stir welding tools. Some embodiments include a combination thereof. Some embodiments include fixed or self-reacting bobbin type friction stir welding tools.

Referring again to FIGS. 1-4, in operation the carriage 12 is positioned so that the pin 18 of the first friction stir welding tool 14 and a pin 20 of the second friction stir welding tool 16 are in operable communication with an intersection of or seam 54 between at least two work pieces 32 and 34. The pin 18 of the first friction stir welding tool 14 is rotated in a first direction and the pin 20 of the second friction stir welding tool 16 is rotated in a second direction, counter to the first direction, simultaneously and in tandem with the rotation of the pin of the first friction stir welding tool. The first friction stir welding tool 14 exerts a greater force on the first work piece 32 than on the second work piece 34. The second friction stir welding tool 16 exerts a greater force on the second work piece 34 than on the first work piece 32 so that a sum of the forces of the first and second stir welding tools on the first and second work pieces urges the carriage 12 and the friction stir welding tools along the seam 54 or intersection of the at least two work pieces in a substantially linear path.

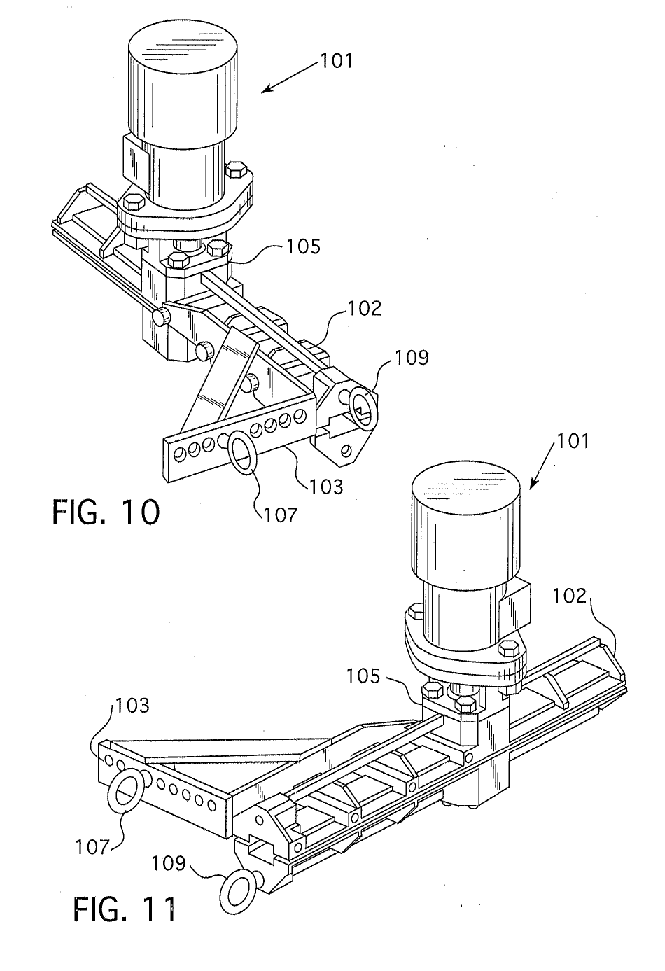

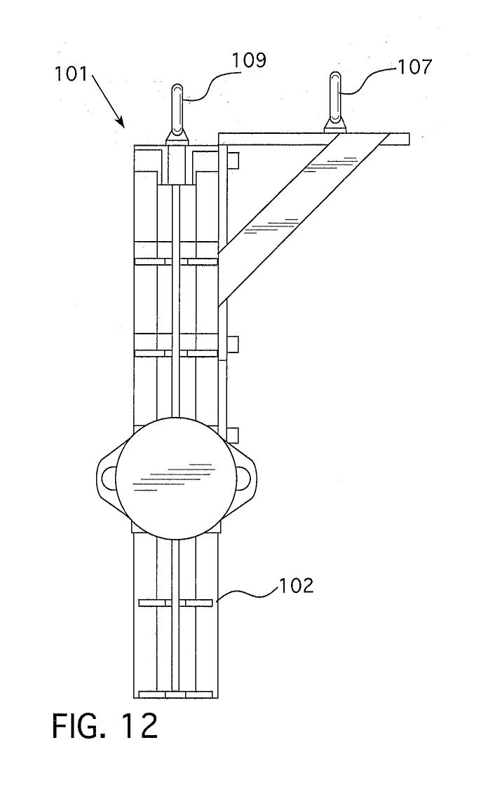

FIGS. 10-12 show an embodiment of a friction stir welding apparatus 101 with a carriage 102 and torque compensation arm 103. The torque compensation arm extends from the carriage 102. The friction stir welding apparatus contains a single friction stir welding tool 105. The torque compensation arm 103 has a ring 107 to which a cable may be attached and pull the friction stir welding apparatus 101. The carriage 102 also has a ring 109. In some embodiments, carriage 102 does not include a ring. A load offset created by cables attached to the rings 107 and 109, or by a cable attached to the ring 107 on the torque compensation arm 103 only, and pulling the friction stir welding apparatus 101 creates a compensation torque that enables the friction stir welding apparatus 101 and friction stir welding tool 105 to travel along a seam between work pieces in a substantially linear path without the need for mechanized tracks, thickened lands or railings. In some embodiments, the distance between the ring 107 on the torque compensation arm 103 and the ring 109 on the carriage 102 is adjustable.

Some embodiments of the invention may include both a torque compensation arm 103 and multiple friction stir welding tools.

In one embodiment of the invention, a portable friction stir welding system includes a carriage 12, which carries two fixed bobbin friction stir welding tools rotating about 200-400 RPM. In this embodiment, the carriage 12 travels about 6 to 20 inches per minute. The friction stir welding system in this embodiment would be well suited to weld a square-butt joint about 6 mm thick.

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means or step for” clause as specified in 35 U.S.C. §112.

1. A friction stir welding apparatus comprising:
a carriage;
a first friction stir welding tool held by the carriage and capable of rotating in a first direction; and
a second friction stir welding tool held by the carriage and capable of rotating in a second direction, counter to the first direction;
wherein the first friction stir welding tool and the second friction stir welding tool are operable to weld simultaneously and in tandem along an intersection of at least two work pieces.

2. The apparatus of claim 1 wherein the intersection comprises a seam formed by an abutment of the work pieces.

3. The apparatus of claim 1 wherein, when welding, the first friction stir welding tool is capable of exerting a greater force on a first work piece than on a second work piece and the second friction stir welding tool is capable of exerting a greater force on the second work piece than on the first work piece so that a sum of the forces of the first and second stir welding tools on the work pieces urges the carriage and the friction stir welding tools along the intersection in a substantially linear path.

4. The apparatus of claim 1 further comprising a third friction stir welding tool held by the carriage wherein, the first friction stir welding tool, the second friction stir welding tool and the third friction stir welding toll are operable to weld simultaneously and in tandem along the intersection, and wherein when welding, a sum of the forces of the stir welding tools on the work pieces urges the carriage and the friction stir welding tools along the intersection in a substantially linear path.

5. The apparatus of claim 1 wherein the second friction stir welding tool is separated from the first friction stir welding tool by a length L along the carriage.

6. The apparatus of claim 1 wherein the first and second friction stir welding tools are capable of traveling along substantially the same linear path.

7. The apparatus of claim 1 wherein the second friction stir welding tool is separated from the first friction stir welding tool by a width W along the carriage.

8. The apparatus of claim 1 wherein the first and second friction stir welding tools are capable of traveling along distinct, parallel linear paths.

9. The apparatus of claim 1 wherein the first friction stir welding tool is the same size and has a same design as the second friction stir welding tool.

10. The apparatus of claim 1 wherein the first friction stir welding tool and the second friction stir welding tool each have a pin and the pin of the first friction stir welding tool is a different size than the pin of the second friction stir welding tool.

11. The apparatus of claim 1 further comprising a mechanism capable of adjusting a turning speed of the first friction stir welding tool or the second friction stir welding tool when welding so that the sum of the forces of the first and second stir welding tools on the work pieces continue to urge the carriage and the friction stir welding tools along the intersection in a substantially linear path as temperature of metal along the seam varies.

12. A method of friction stir welding comprising:
positioning a carriage having at least a first friction stir welding tool and a second friction stir welding tool so that a pin of the first friction stir welding tool and a pin of the second friction stir welding tool are in operable communication with an intersection of at least two work pieces;
rotating in a first direction the pin of the first friction stir welding tool; and
rotating the pin of the second friction stir welding tool in a second direction, counter to the first direction, simultaneously and in tandem with the rotation of the pin of the first friction stir welding tool;
wherein the first friction stir welding tool exerts a greater force on a first work piece than on a second work piece and the second friction stir welding tool exerts a greater force on the second work piece than on the first work piece so that a sum of the forces of the first and second stir welding tools on the first and second work pieces urges the carriage and the friction stir welding tools along the intersection of the at least two work pieces in a substantially linear path.

13. The method of claim 12 wherein the second friction stir welding tool is separated from the first friction stir welding tool by a length L along the carriage.

14. The method of claim 12 wherein the first and second friction stir welding tools travel along substantially the same linear path.

15. The method of claim 12 wherein the second friction stir welding tool is separated from the first friction stir welding tool by a width W along the carriage.

16. The method of claim 12 wherein the first and second friction stir welding tools travel along distinct, parallel linear paths.

17. The method of claim 12 wherein the first friction stir welding tool is the same size and has a same design as the second friction stir welding tool.

18. The method of claim 12 wherein the first friction stir welding tool and the second friction stir welding tool each have a pin and the pin of the first friction stir welding tool is a different size than the pin of the second friction stir welding tool.

19. The method of claim 12 further comprising adjusting a turning speed of the first friction stir welding tool or the second friction stir welding tool when welding so that the sum of the forces of the first and second stir welding tools on the work pieces continue to urge the carriage and the friction stir welding tools along the intersection in a substantially linear path as temperature of metal along the seam varies.

20. A friction stir welding apparatus comprising:
a carriage;
a first friction stir welding tool held by the carriage; and
a torque compensation arm held by the carriage and capable of being pulled by a cable.
